(19) United States
(12) Patent Application Publication
(10) Pub. No.: US 2002/0005423 A1
(43) Pub. Date: Jan. 17, 2002

(54) Hitch-mounted tilting cargo carrier

(76) Inventor: Donald D. Grover, Rothschild, WI (US)

Correspondence Address: MascoTech, Inc., 21001 Van Born Rd., Taylor, MI, 48180, US

(21) Appl. No.: 09/851,690

(22) Filed: May 9, 2001

Related U.S. Application Data
(60) Provisional application No. 60/204,657, filed on May 17, 2000.

(51) Int. Cl. B60R 9/00; B60R 11/00

(52) U.S. Cl. 224/509; 224/519

(57) ABSTRACT

A hitch-mounted cargo carrier for a vehicle which includes a platform that can be selectively tilted downwardly to facilitate loading of the carrier. Upon loading the platform, the platform may be raised for transport of the load. The carrier includes a fixed frame which is removably mounted to the hitch. A pair of pivotable arms are attached to the frame. The other end of the arms are pivotably attached to the platform. A jack assembly associated with the frame pivots the arms to move the platform. The arms have different lengths such that pivoting movement cases one end of the platform to tilt downwardly.

### RELATED APPLICATIONS

This application claims priority from U.S. Provisional Application No. 60/204,657 filed on May 17, 2000.

### BACKGROUND OF THE INVENTION

I. Field of the Invention

This invention relates to cargo carriers mounted to a hitch assembly of a vehicle and, in particular, to a hitch mounted carrier with a platform which can be selectively tilted downwardly to facilitate loading of the carrier.

II. Description of the Prior Art

With the increased popularity of sport utility vehicles and similar recreational vehicles, vehicle owners have sought convenient means for transporting even more cargo and even secondary vehicles. One well-known tool for increasing the cargo capacity of the vehicle is a rear mounted deck or other carrier. Typically, these carriers are removably mounted to a hitch receiver of the vehicle to position the carrier proximate the rear bumper. Because these carriers are stationary large items must be lifted onto the carrier platform.

Mechanically operated platforms have also been developed to assist in the loading and transport of large items including secondary vehicles such as scooters and wheelchairs. These prior known lifts are heavy structures requiring substantial superstructures which must be supported by the vehicle frame. As a result, these lifts are bulky and expensive and therefore used only for special requirements.

### SUMMARY OF THE PRESENT INVENTION

The present invention overcomes the disadvantages of the prior known cargo carriers mounted to a vehicle by providing a hitch-mounted carrier which can be easily lowered to a tilted position to facilitate the loading of cargo including secondary vehicles such as wheelchairs, scooters and recreational vehicles.

The cargo carrier of the present invention is removably mounted to a hitch structure secured to the rear of a vehicle. The carrier may be removed when not in use simply by detaching the carrier from the hitch structure. The carrier has an upright stationary frame which includes at least one beam adapted to be matingly received in corresponding bosses of the hitch structure. Movably attached to the frame is a cargo platform. The platform is attached to the frame by a pair of movable arms, one end of which are pivotably connected to the frame and the other end of which are pivotably connected to the platform. In a preferred embodiment of the invention, the arms are unequal in length such that when extended, the platform will tilt downwardly forming a ramp upon which the cargo is loaded.

The pivoting movement of the arms and therefore the deployment of the platform is controlled by a jack assembly mounted to the fixed frame. The jack includes telescopically extendable tube attached to the frame. The retraction and extension of the tube is controlled through a crank drivably connected to a gear system. As the crank is operated, the inner tube will be extended to move the platform between a raised position and a lowered position proximate the ground.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a hitch-mounted tilting cargo carrier embodying the present invention mounted to the rear of a vehicle;

FIG. 2 is a top view thereof;

FIG. 3 is a rear view of the cargo carrier;

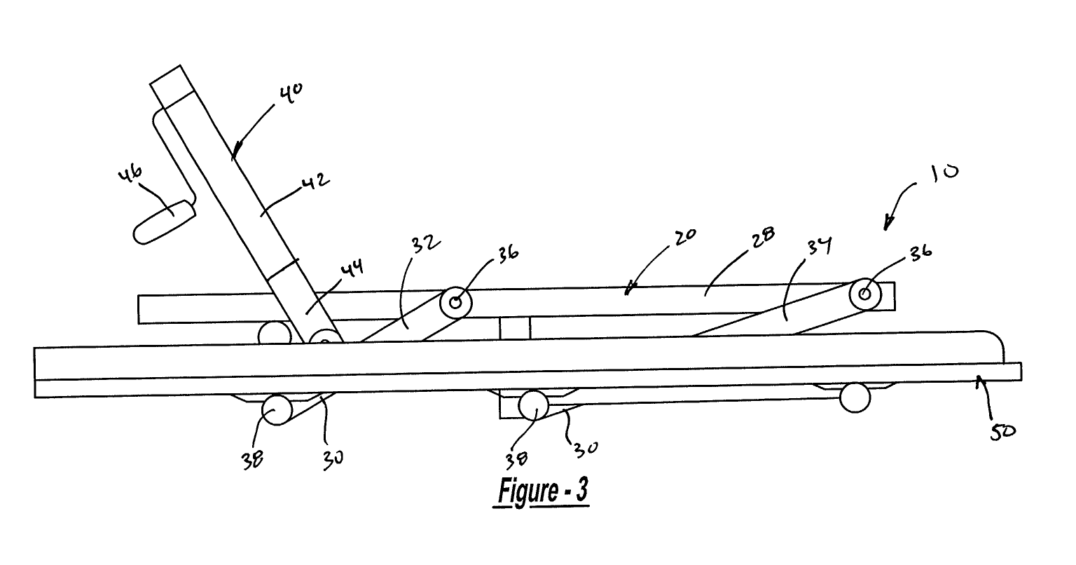

FIG. 4 is a rear view of the cargo carrier lowered to a tilted position for loading and unloading; and

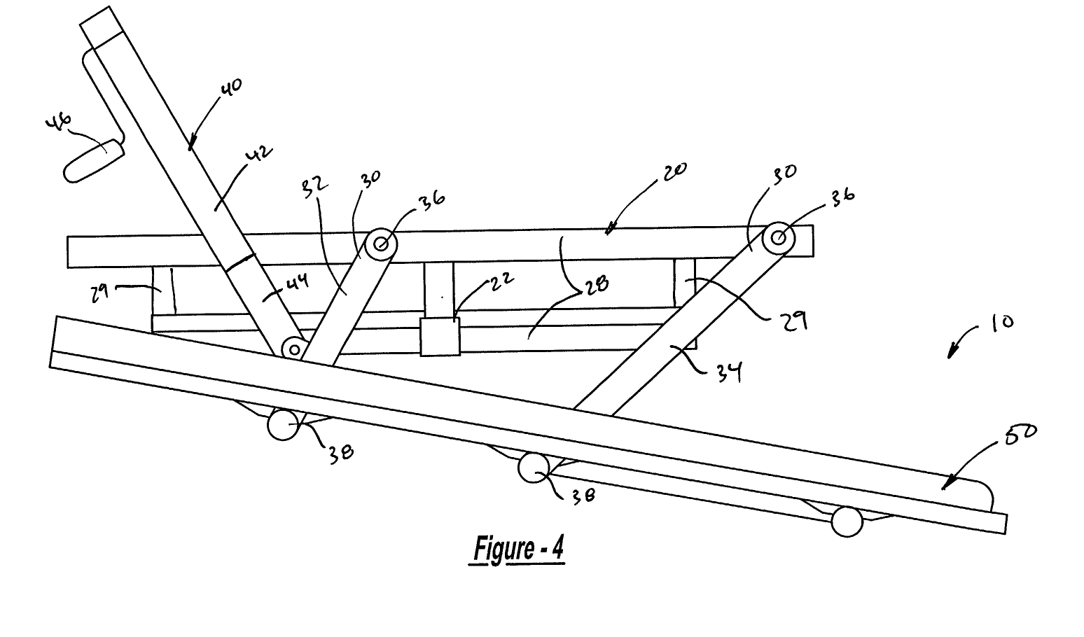

FIG. 5 is an end view of the cargo carrier.

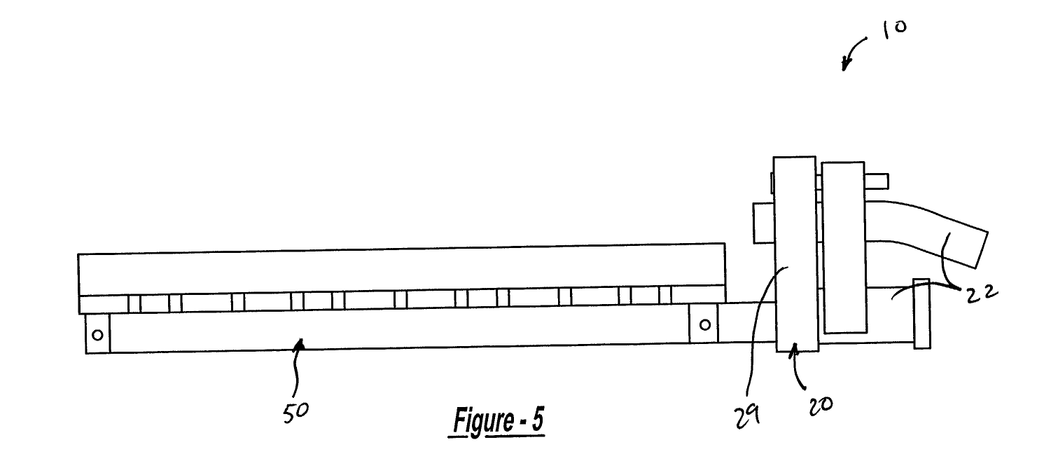

### DETAILED DESCRIPTION OF A PREFERRED EMBODIMENT OF THE PRESENT INVENTION

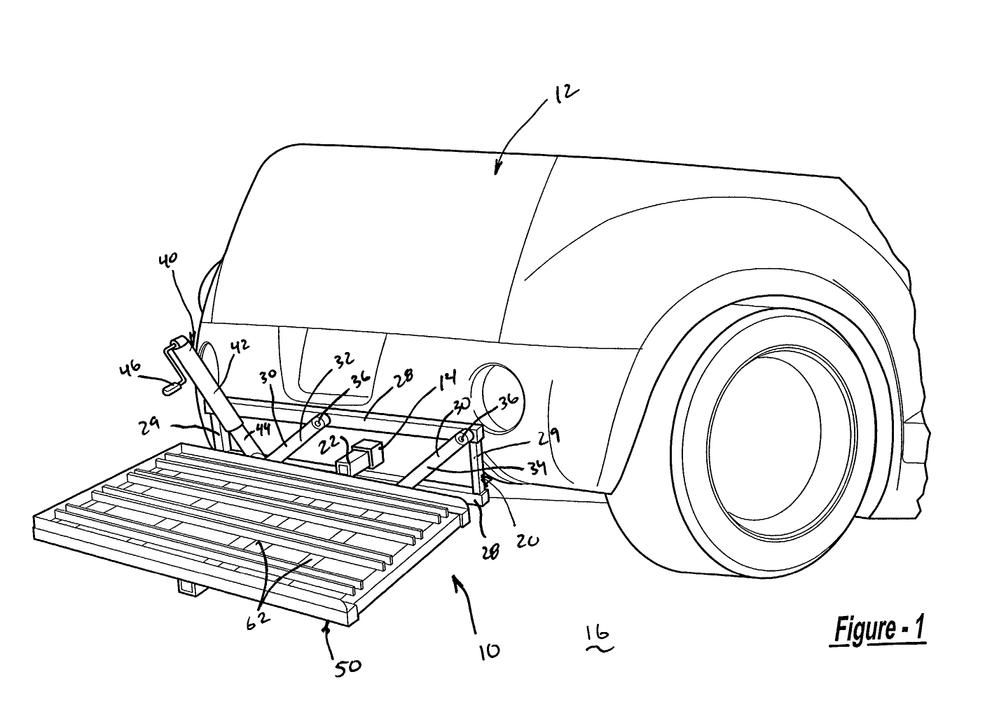

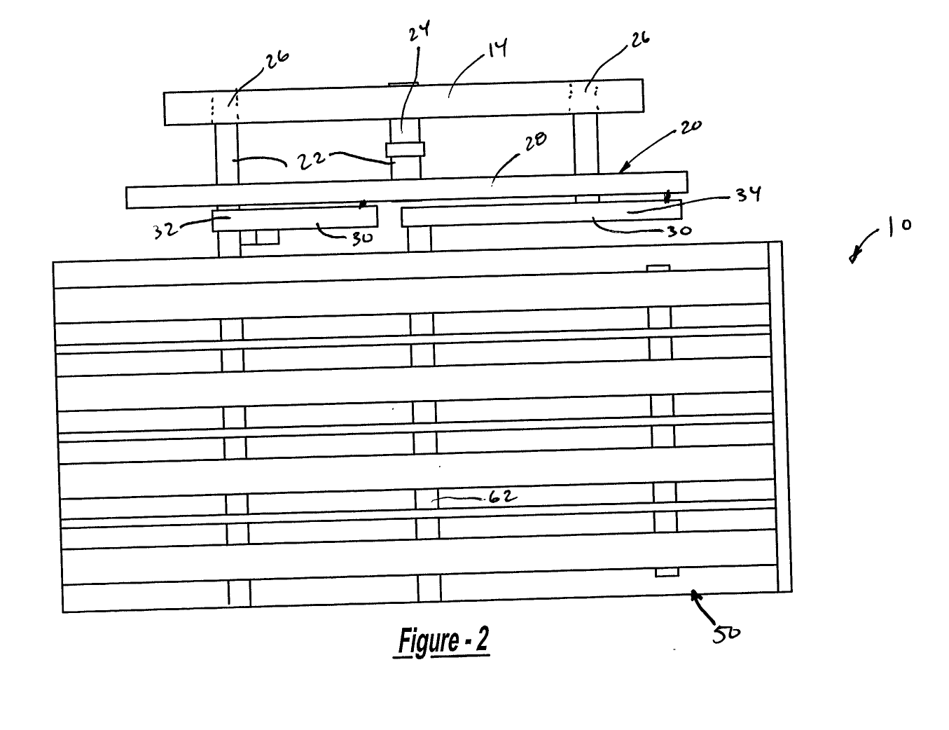

Referring first to FIGS. 1 and 2, there is shown a cargo carrier 10 adapted to be mounted to the rear of a vehicle 12. In a preferred embodiment of the invention, the carrier 10 is detachably mounted to a towing hitch structure 14 fixedly secured to the vehicle 12 proximate the rear bumper of the vehicle 12. As a result, the carrier 10 will transport a load at the rear of the vehicle 12. When not in use, the carrier 10 may be detached from the hitch 14 and stored away. Unlike well-known stationary carriers, the cargo carrier 10 of the present invention is selectively movable between a raised position and a lowered position proximate the ground 16 for loading and unloading as will be subsequently described.

The cargo carrier 10 includes a fixed frame 20 detachably mountable to the hitch 14. The frame 20 is disposed substantially upright and has at least one hitch receiver bar 22 extending perpendicular to the frame 20. The at least one hitch receiver bar 22 is adapted to be received either in a hitch sleeve 24 or a boss 26 of the hitch assembly 14 depending upon the hitch type mounted to vehicle 12. The frame 20 may include horizontal supports 28 and vertical cross-members 29.

Pivotably attached to the frame 20 are at least a pair of pivot arms 30. A preferred embodiment of the invention comprises two pivot arms 30 including a first pivot arm 32 and a second pivot arm 34 having a greater length than the first arm 32 in order to tilt the carrier in accordance with the present invention. An upper end 36 of the arms 30 is pivotably connected to the fixed frame 20. A lower end 38 of the arms 30 is pivotably connected to a platform 50. The pivoting movement of the arms 30 is preferably controlled by a manually operated jack 40 although any type of mechanical assembly could be used to control the movement of the arms 30 and, consequently, deployment of the platform 50.

The jack 40 of the present invention includes a housing 42 secured to the frame 20 and a telescoping arm 44 extending from the housing 42. The telescoping arm 44 is attached to one of the pivot arms 30 such that upon extension of the jack arm 44, the pivot arms 30 will be moved downwardly. The telescoping movement of the jack arm 44 is controlled by a gear assembly operably connected to a crank 46.

The carrier platform 50 is attached to the lower end 38 of the pivot arms 30 for movement therewith. The platform 50 will preferably have a rectangular configuration dimensioned according to the intended end use of the carrier 10. The pivot arms 30 are pivotably connected to one edge 52 of the platform 50. The platform 50 may comprise a simple frame, a series of parallel rails, or a flat platform according to the intended use. As further alternatives, a ramp or a cargo housing may be secured to the platform 50. Cross support beams 62 extend beneath the platform 50 and are connected directly to the pivot arms 30. The crossbeams 62 may be pivotably connected to the platform 50 to facilitate movement.

Operation of the carrier 10 facilitates loading, transport and unloading of even heavy cargo without lifting the cargo onto a raised platform. The platform 50 will normally be maintained in the raised position substantially parallel to and spaced above the ground 16. Winding of the crank 46 in a first direction will telescope the arm 44 of the jack 40 outwardly pivoting the arms 30 downwardly. The unequal length of the pivot arms 30 will cause a first end of the platform 50 to drop farther than the other until the first end engages the ground 16. The load can then be moved up the ramp-like platform 50 and into position. The rotation of the crank 46 is reversed to pull the telescoping arm 44 into the housing 42 thereby drawing the pivot arms 30 upwardly until the platform is substantially parallel to the ground 16. With the platform 50 in the raised position, the load in the cargo carrier 10 can be transported with the vehicle.

During non-use, the cargo carrier 10 can be detached from the hitch assembly 14 by removing the hitch receiver bar 22 depending upon the mounting of the cargo carrier 10.

The foregoing detailed description has been given for clearness of understanding only and no unnecessary limitations should be understood therefrom as some modifications will be obvious to those skilled in the art without departing from the scope and spirit of the appended claims.

What is claimed is:

1. A selectively movable cargo carrier adapted to be mounted to a hitch structure of a vehicle, said cargo carrier comprising:
a fixed support structure adapted to be mounted to the vehicle hitch structure;
at least two pivot arms pivotably mounted to said support structure; and
a platform pivotably attached to said at least two pivot arms, said platform selectively movable between a raised position and a lowered position.

2. The carrier as defined in claim 1 and further comprising means for moving said platform between said raised and lowered positions.

3. The carrier as defined in claim 2 wherein said means includes a jack mounted to said support structure and having a telescoping tube connected to said platform for selectively moving said platform between said raised position and said lowered position upon operation of said jack.

4. The carrier as defined in claim 3 wherein said carrier includes a pair of pivot arms pivotably attached to said support structure and said platform, a first pivot arm having a length greater than a length of a second pivot arm such that upon operation of said jack a firs tend of said platform is lowered a greater distance than a second end of said platform.

5. The carrier as defined in claim 3 wherein said support structure includes at least one receiver bar adapted to be received in the hitch for support on the rear of the vehicle.

6. The carrier as defined in claim 5 wherein said support structure includes a pair of receiver bars adapted to be received within a dual port vehicle hitch.

7. The carrier as defined in claim 5 wherein said platform includes a housing for protecting cargo stored on the carrier.

8. A cargo carrier adapted to be mounted to a hitch structure of a vehicle, said cargo carrier comprising:
a fixed support structure having means for mounting to the vehicle hitch structure;
a pair of pivot arms pivotably attached to said support structure and laterally spaced along said support structure;
a movable cargo platform attached to said pivot arms; and
deployment means attached to said support structure and engaging said cargo platform to selectively move said platform between a raised position and a lowered position.

9. The carrier as defined in claim 8 wherein said deployment means includes a mechanical jack attached to said support structure and including a telescoping arm connected to said platform for selectively moving said platform between said raised position and said lowered position upon operation of said jack.

10. The carrier as defined in claim 9 wherein said pair of pivot arms includes a first pivot arm having a length greater than a length of a second pivot arm such that upon operation of said jack, a first end of said platform is lowered a greater distance than a second end of said platform.

11. The carrier as defined in claim 9 wherein said support structure includes at least one receiver bar adapted to be received in the hitch for support on the rear of the vehicle.

12. The carrier as defined in claim 11 wherein said support structure includes a pair of receiver bars adapted to be received within a dual port vehicle hitch.

13. The carrier as defined in claim 11 wherein said platform includes a housing for protecting cargo stored on the carrier.
